(19) United States
(12) Patent Application Publication
(10) Pub. No.: US 2026/0154056 A1
(43) Pub. Date: Jun. 4, 2026

(54) ELECTIONS OF PROGRAM IMAGE PROVIDERS

(71) Applicant: HEWLETT PACKARD ENTERPRISE DEVELOPMENT LP, Spring, TX (US)

(72) Inventors: Guo Xiao, Beijing (CN); Xing Li, Beijing (CN); Yanmin Liu, Beijing (CN)

(21) Appl. No.: 18/964,754

(22) Filed: Dec. 2, 2024

(51) Int. Cl. G06F 8/65

(52) U.S. Cl. CPC G06F 8/65

(57) ABSTRACT

In some examples, a first network device performs an election process with other network devices to determine which of a plurality of network devices is to be a provider of a first program image module of a program image divided into multiple program image modules. As part of the election process, the first network device exchanges information of operational properties of the plurality of network devices. Based on the information of operational properties of the plurality of network devices, first network device determines whether the first network device is elected as the provider of the first program image module.

### BACKGROUND

A network includes network devices that are used to forward data sent by source devices to destination devices. Examples of network devices include access points (APs), switches, routers, or other types of network devices.

### BRIEF DESCRIPTION OF THE DRAWINGS

Some implementations of the present disclosure are described with respect to the following figures.

FIG. 1 is a block diagram of an arrangement including access points (APs) and a remote source of program image modules (PIMs), according to some examples.

FIG. 2 is a block diagram of a modules table, according to some examples.

FIG. 3 is a flow diagram of an election process according to some examples.

FIG. 4 is a flow diagram of a process involving multiple APs, according to some examples.

FIG. 5 is a flow diagram of a failover process, according to some examples.

FIG. 6 is a block diagram of a network device according to some examples.

FIG. 7 is a block diagram of a storage medium storing machine-readable instructions according to some examples.

FIG. 8 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Network devices can execute machine-readable instructions to perform tasks of the network devices, including forwarding data in a network. The machine-readable instructions can include one or both of firmware and software. During the operation of a network device, the machine-readable instructions are loaded to a memory of the network device and executed by a processing resource of the network device. A processing resource includes one or more hardware processors. The memory into which the machine-readable instructions are loaded for execution can include volatile memory, such as a dynamic random access memory (DRAM). The volatile memory may also include a static random access memory (SRAM).

A nonvolatile memory in the network device may be relatively small as compared to the volatile memory. An example of the nonvolatile memory includes a flash memory, an erasable and programmable read-only memory (EPROM), an electrically erasable and programmable read-only memory (EEPROM), or any other memory in which stored data is maintained (i.e., not lost) if the network device is powered off. Due to the small size of the nonvolatile memory, it may not be possible to store, in the nonvolatile memory, the entire program image containing the machine-readable instructions of the network device. As a result, when the network device is initially deployed, the program image is not available in the network device's nonvolatile memory. Instead, the network device downloads the program image from a remote source, such as a storage system in a cloud computing environment, a remote server, or another remote system. The downloaded program image is loaded into the volatile memory of the network device and executed.

In some cases, a network connection between the network device and the remote source of the program image may be slow, unreliable, or down. The poor or unavailable network connection may lead to delays in downloading the program image, which can prevent the network device from starting up to begin operations. If a large quantity of network devices is being started at around the same time, that can lead to a large portion of the network being unavailable until the network devices are able to successfully download, from the remote source, their respective program images for execution.

A further issue is associated with program image updates. When a program image is updated, the network devices of the network may initiate the download of the updated program image. If there is a large quantity of network devices, that can lead to a communication bottleneck between the network devices and the remote source of the updated program image.

In accordance with some implementations of the present disclosure, a program image for network devices is partitioned into smaller program image modules (PIMs) that are stored at respective different network devices. For example, a first network device stores a first PIM of the program image, a second network device stores a second PIM of the program image, and so forth. Note that any given network device may store multiple PIMs of the program image. In some cases, multiple network devices may store the same PIM(s). The network devices can participate in an election process to determine which network device is to be an image provider (or more simply, a “provider”) of a given PIM of the program image. As part of the election process, the network devices exchange information of operational properties of the network devices. Based on the information of operational properties of the network devices, a network device determines whether the network device is elected as the provider of the given PIM.

Techniques or mechanisms according to some examples of the present disclosure allow for program images of network devices with restricted capacity nonvolatile memories to be reliably downloaded to the network devices as separate PIMs so that the network devices do not experience operational delays due to poor or unavailable connections to remote sources of program images. Also, network devices do not have to be configured with costly large nonvolatile memories to support large program images. Additionally, updates of PIMs can be downloaded by providers of the PIMs, so that a large number of network devices would not be concurrently downloading updated PIMs at the same time, which can be create a communication bottleneck with a remote source.

A program image can refer to a collection of program code (in the form of one or more files or other types of objects) that is to be executed by a processing resource. A “PIM” refers to a portion (less than the entirety) of the program image. An “image provider” (or more simply, a “provider”) of a PIM is a network device that has a copy of the PIM stored in a nonvolatile memory of the network device, and this network device is to transmit the PIM to another network device in response to a request for the PIM from the other network device.

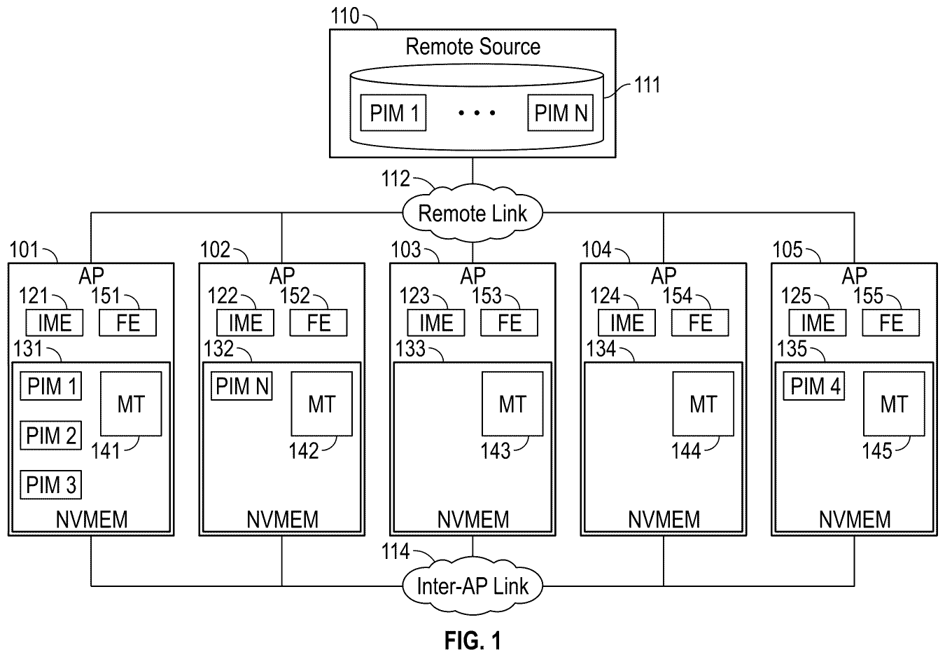

FIG. 1 is a block diagram of an example arrangement that includes various APs 101, 102, 103, 104, and 105, and a remote source 110. The remote source 110 can include a cloud computing environment, a remote server, or any other system coupled over a remote link 112. The remote link 112 can include a public network such as the Internet, or another type of network such as a wide area network (WAN). The remote link 112 can be a wired network or a wireless network.

Although FIG. 1 shows a specific quantity of APs, in other examples, a different quantity of APs may be provided. Also, more generally, techniques or mechanisms according to some examples of the present disclosure are applicable to other types of network devices besides APs, such as switches, routers, gateways, and so forth.

The remote source 110 includes a program image repository 111 that contains PIM 1 to PIM N, where N≥2, of a program image. The program image repository 111 can be implemented using one or more storage devices, such as disk-based storage devices, flash memory devices, or other types of storage devices. The program image may have been partitioned into PIMs 1 to N by the remote source 110, or by a different entity. Note that the remote source 110 may store PIMs for multiple different program images. Each of the different program images can be partitioned into a respective group of PIMs that are stored in the program image repository 111.

The APs 101 to 105 are connected to one another over an inter-AP link 114, which can include a local area network (LAN), a WAN, or another type of network. The inter-AP link 114 can be a wired or wireless network. The inter-AP link 114 allows the APs 101 to 105 to communicate with one another.

The APs 101 to 105 include respective image module engines (IMEs) that participate in election processes for electing which AP is to be a provider of any given PIM. The AP 101 includes an IME 121, the AP 102 includes an IME 122, the AP 103 includes an IME 123, the AP 104 includes an IME 124, and the AP 105 includes an IME 125. In an election process, an AP may be elected as a provider of one or more PIMs.

Further, each AP includes a respective failover engine (FE) to take over provider responsibilities in case a current provider of a PIM goes down. The AP 101 includes an FE 151, the AP 102 includes an FE 152, the AP 103 includes an FE 153, the AP 104 includes an FE 154, and the AP 105 includes an FE 155.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

Each AP also includes a respective nonvolatile memory. The AP 101 includes a nonvolatile memory 131, the AP 102 includes a nonvolatile memory 132, the AP 103 includes a nonvolatile memory 133, the AP 104 includes a nonvolatile memory 134, and the AP 105 includes a nonvolatile memory 135. Each AP also includes a respective volatile memory (not shown). Some APs may have nonvolatile memories with greater memory capacities than other APs.

In the example of FIG. 1, PIMs 1, 2, and 3 are stored in the nonvolatile memory 131 of the AP 101, PIM N is stored in the nonvolatile memory 132 of the AP 102, and PIM 4 is stored in the nonvolatile memory 135 of the AP 105. The APs 101, 102, and 105 may have downloaded the respective PIMs from the remote source 110. Alternatively, an AP may also have obtained a PIM from another AP.

In the example of FIG. 1, the APs 103 and 104 do yet not contain any PIMs in their respective nonvolatile memories 133 and 134. For example, the APs 103 and 104 may have just started operation in the network. Also, in the example state represented by FIG. 1, each of the APs 101 to 105 is missing some PIMs of the program image. Each AP can obtain any missing PIM from a provider of the PIM as elected in an election process.

The nonvolatile memory of each AP also contains a modules table (MT), which contains entries that relate respective PIMs to various information elements. The MT identifies all of the PIMs of a program image that are to be loaded to an AP.

An MT 141 is stored in the nonvolatile memory 131 of the AP 101, an MT 142 is stored in the nonvolatile memory 132 of the AP 102, an MT 143 is stored in the nonvolatile memory 133 of the AP 103, an MT 144 is stored in a nonvolatile memory 134 of the AP 104, and an MT 145 is stored in the nonvolatile memory 135 of the AP 105. A “table” can refer to any data structure that contains information in respective entries.

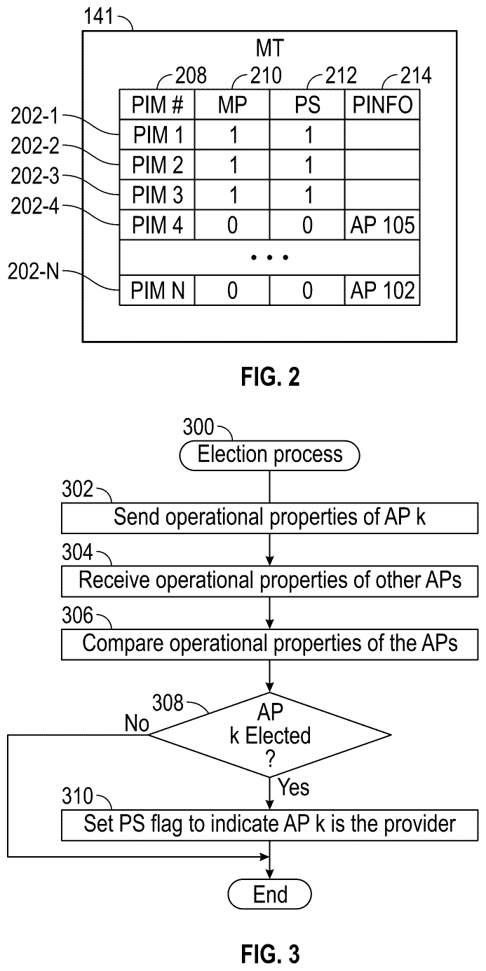

Referring further to FIG. 2, an example content of the MT 141 stored in the AP 101 is shown. The MT 141 includes entries 202-1, 202-2, 202-3, 202-4, . . . , 202-N containing information elements for respective PIMs 1, 2, 3, 4, . . . , N. The MTs in the other APs may have similar arrangements (but with different content).

A PIM identifier column 208 identifies a PIM. The PIM identifier may be a PIM number, with different PIMs assigned different PIM numbers. Other types of PIM identifiers can be used in other examples. Each entry of the MT 141 further includes a module present (MP) flag 210, a module provider status (PS) flag 212, and provider information (PINFO) 214. A “flag” refers to any information element that may be set to one of multiple different values.

The MP (module present) flag 210 in an entry 202-j (j=1 to N) indicates whether a respective PIM j is present in the nonvolatile memory 131 of the AP 101. The MP flag 210 in the entry 202-j if set to a first value (e.g., “1”) indicates that PIM j is present; however, the MP flag 210 in the entry 202-j if set to a different second value (e.g., “0”) indicates that PIM j is not present. The MP flag 210 is set to “1” in the entries 202-1, 202-2, and 202-3 to indicate that PIMs 1, 2, and 3 are present in the nonvolatile memory 131 of the AP 101. The MP flag 210 is set to “0” in the entries 202-4 and 202-N to indicate that PIMs 4 and N are not present in the nonvolatile memory 131 of the AP 101. When the MP flag 210 is set to “0” in an entry 202-j, the AP 101 would request PIM j from another AP.

The PS (module provider status) flag 212 in the entry 202-j indicates whether the AP 101 is the provider of PIM j, as elected in an election process among multiple APs. The PS flag 212 in the entry 202-j if set to a first value (e.g., “1”) indicates that the AP 101 is the provider of PIM j; however, the MP flag 210 in the entry 202-j if set to a different second value (e.g., “0”) indicates that the AP 101 is not the provider of PIM j.

In the example of FIG. 1, it is assumed that the AP 101 has been elected as the provider of PIMs 1, 2, and 3. Thus, the PS flag 212 in each of the entries 202-1, 202-2, and 202-3 is set to “1.” However, the AP 101 has not been elected as the provider of PIMs 4 and N. As a result, the PS flag 212 in each of the entries 202-4 and 202-N is set to “0.”

In some examples, each entry of the MT 141 can also store PIM provider information (PINFO) 214. The PINFO 214 in each entry indicates, for a PIM for which the AP 101 is not the image provider, which other AP is the image provider. The PIM provider information 214 in an entry 202-j of the MT 141 can include an identifier of the AP that is the provider of PIM j. The identifier can be in the form of a network address, such as a Media Access Control (MAC) address, an Internet Protocol (IP) address, or another type of identifier. The PIM provider information 214 allows the AP 101 to track which other AP is the provider of a given PIM.

In the example of FIG. 2, the PINFO 214 of the entry 202-4 contains an identifier of the AP 105, which indicates that the AP 105 is the provider of PIM 4. The PINFO 214 of the entry 202-N contains an identifier of the AP 102, which indicates that the AP 102 is the provider of PIM N. The PINFO 214 in entries 202-1, 202-2, and 202-3 are blank or contain null information, since the AP 101 is the provider of PIMs 1, 2, and 3.

Although not shown, it is possible that multiple APs are elected as providers of any given PIM. Also, in some examples, primary and backup providers of a given PIM can be elected. The primary provider is the AP that would provide the given PIM to a requesting AP. If the primary PIM fails, the backup AP can take over as the PIM provider.

FIG. 3 is a flow diagram of an election process 300 performed by an IME in AP k, which can be any of APs 101 to 105 in FIG. 1. The election process 300 can be initiated in response to a triggering event. For example, the IME in AP k may initiate the election process 300 after sending a discover message for PIM j, and not receiving a response containing PIM j after a specified timeout duration. Expiration of this timeout duration indicates that either no provider has yet been elected for PIM j, or alternatively, the provider of PIM j is down. If AP k initiated the election process 300, then the IME in AP k can send an election trigger message to the other APs to participate in the election process 300. Another example of a triggering event for the election process 300 is a receipt of an election trigger message from another AP that initiated an election process at the other AP.

As part of the election process 300 for PIM j, the IME in AP k sends (at 302) operational properties of AP k to the other APs over the inter-AP link 114 (FIG. 1). Examples of operational properties can include any or some combination of the following: an available memory capacity of the nonvolatile memory of AP k; a network performance metric (e.g., latency, error rate, etc.) associated with network connectivity between AP k and the remote source 110; an uptime metric representing a length of time that AP k has been up; a usage metric (e.g., number of cores used, quantity of instructions executed per unit time, etc.) of a processing resource of the AP k; or any other operational property indicating how well AP k is performing.

Note that the available memory capacity of the nonvolatile memory of AP k is reduced as PIM(s) are stored in the nonvolatile memory of AP k. As a result, as the nonvolatile memory of AP k fills up with PIM(s), other APs would be better candidates to act as providers of other PIMs.

AP k receives (at 304) operational properties of other APs over the inter-AP link 114. Based on comparing (at 306) operational properties of AP k to operational properties of the other APs, the IME of AP k can determine (at 308) whether AP k is to be elected as the provider of PIM j.

In some examples, the operational properties of each AP can be combined by aggregating (e.g., summing or another type of mathematical aggregate operation) the operational properties to produce a score for each AP. The scores can then be compared to determine which AP should be elected as the provider of PIM j. In examples where a higher score indicates that the respective AP is a better candidate as a provider of PIM j, the following characteristics of AP k would tend to increase the score of AP k: a greater memory capacity of the nonvolatile memory of AP k, a network performance metric indicating a faster or more reliable connectivity between the AP k and the remote source 110, a usage metric indicating a lower load at AP k, and so forth.

If the IME of AP k determines that AP k is elected as the provider of PIM j based on comparing the scores, the IME in AP k sets (at 310) the PS flag 212 in the entry 202-j to “1.” If PIM j is not already present in AP k, AP k downloads PIM j from the remote source 110, and stores the downloaded PIM j into the nonvolatile memory of AP k. The IME in AP k also sends to the other APs a provider elected message indicating that AP k is elected as the provider of PIM j.

It is noted that in the election process 300, AP k can be elected as an image provider of multiple PIMs, including PIM j. If AP k is not elected as the provider of PIM j, the election process 300 ends.

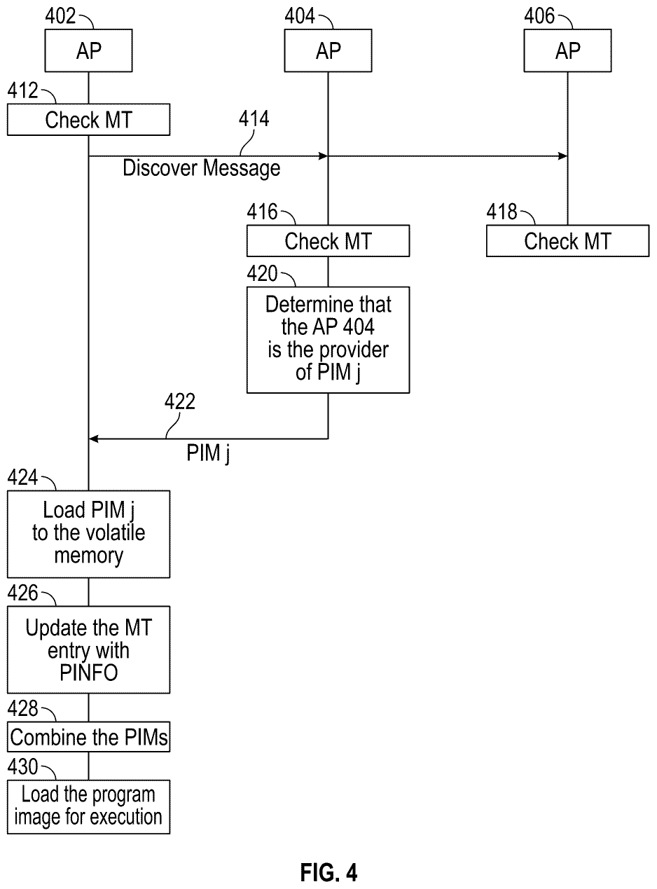

FIG. 4 is a flow diagram of a process involving multiple APs 402, 404, and 406. When the AP 402 initially starts (e.g., when the AP 402 is initially deployed or when the AP 402 has been restarted such as due to a power cycle or reboot), the AP 402 checks (at 412) its MT to determine which PIMs of a program image are to be loaded for execution, and which of those PIMs are already stored in the nonvolatile memory of the AP 402. If the AP 402 determines that PIM j is not present in the nonvolatile memory of the AP 302, the AP 402 sends (at 414) a discover message for PIM j to the other APs 404 and 406. The discover message is a broadcast message sent over the inter-AP link 114 to request PIM j. A broadcast message is targeted to multiple APs. For example, the broadcast message can include a destination broadcast address, such as a broadcast MAC address or broadcast IP address, which indicates that the message is intended to be received by multiple target endpoints associated with the broadcast destination address.

In response to the discovery message, the AP 404 checks (at 416) its MT to determine whether the AP 404 is the provider of PIM j. Similarly, the AP 406 checks (at 418) its MT to determine whether the AP 406 is the provider of PIM j.

In the example of FIG. 4, it is assumed that the AP 404 has determined (at 420) that the AP 404 is the provider of PIM j. As a result, the AP 404 sends (at 422), as a response to the discover message from the AP 402, PIM j retrieved from the nonvolatile memory of the AP 404 to the AP 402. In response to receipt of PIM j, the AP 402 loads (at 424) PIM j to the volatile memory of the AP 402. The AP 402 also updates (at 426) the MT entry 202-j for PIM j with the PIM provider information (PINFO) that identifies the AP 404 as the provider of PIM j.

A similar process is performed for each other PIM that is not present in the nonvolatile memory of the AP 402. Once all PIMs of the program image are present in the AP 402 (either already present in the nonvolatile memory of the AP 402 or received from one or more other APs), the AP 402 can combine (at 428) the PIMs to form the program image that is then loaded (at 430) into the volatile memory of the AP 402 for execution to perform the tasks of the AP 402.

The FEs (e.g., 151 to 155 in FIG. 1) of the APs are able to perform failover in case an image provider becomes unavailable for any reason. An FE can send periodic heartbeat indicators to other APs to determine whether the other APs are still available. A “heartbeat indicator” can refer to a message, an information element, or a signal that is sent on a periodic basis to a target, with the expectation that the target responds if the target is available. Lack of a response from the target (after a specified heartbeat timeout duration) to the heartbeat indicator indicates that the target is no longer available.

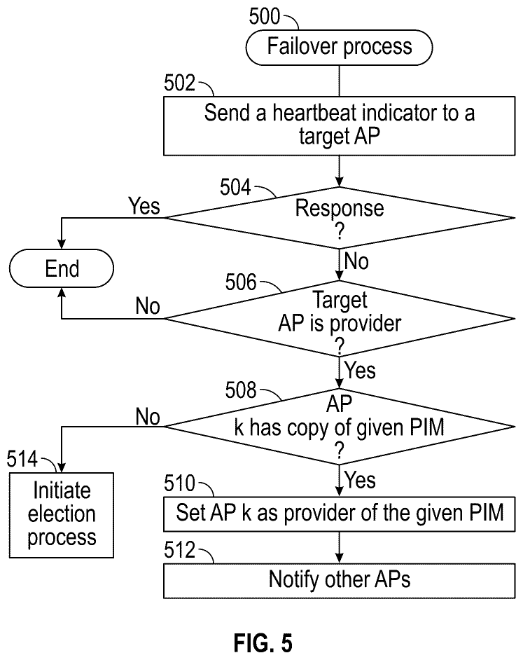

FIG. 5 shows a failover process 500 performed by an FE in AP k. The FE in AP k sends (at 502) a heartbeat indicator to a target AP. The FE in AP k determines (at 504) whether a response to the heartbeat indicator is received. If so, then the failover process 500 ends. However, if the FE in AP k determines (at 504) that the response to the heartbeat indicator is not received within the specified heartbeat timeout duration, the FE in AP k checks its MT to determine (at 506) whether the target AP is a provider of any PIM. If the target AP is not a provider of any PIM, then the failover process 500 ends. However, if the target AP is a provider of a given PIM, the FE in AP k determines (at 508) whether AP k has a copy of the given PIM in the nonvolatile memory of AP k. If so, the FE in AP k can set (at 510) AP k as the provider of the given PIM. The FE in AP k can notify (at 512) the other APs that the FE in AP k has become the provider of the given AP, such as by sending a provider elected message to the other APs.

If the FE in AP k determines (at 508) that AP k does not have a copy of the given PIM, the FE in AP k can initiate (at 514) an election process with other APs to elect which AP is to be the provider of the given PIM. For example, AP k can send an election trigger message to the other APs.

Before initiating the election process, the FE in AP k can wait to determine whether another AP has sent a provider elected message indicating that the other AP has been set as the provider of the given PIM. If no other AP has sent a provider elected message indicating that the other AP has been set as the provider of the given PIM, then AP k can initiate the election process for the given PIM.

It is also possible that FEs in multiple APs can set the respective multiple APs as providers of the given PIM. In this scenario, one or more of the FEs can detect that multiple APs are providers of the same PIM. If this condition is not allowed, then the FEs can initiate an election process to elect a provider of the given PIM. In other examples, one of the multiple APs can be set as a primary provider and another AP can be set as a backup provider of the given PIM, such as based on a backup election process between the multiple APs to elect one of the multiple APs as the primary provider and the other AP as a backup provider. The backup election can be based on comparing operational properties of the multiple APs for example.

An AP that is a provider of PIM j is responsible for obtaining updates of PIM j. An updated PIM j may be downloaded from the remote source 110. Alternatively, the AP that is the provider of PIM j can notify the remote source 110 that the AP is to be provided with updates of PIM as they become available. Once the AP downloads an updated PIM j, the AP sends the updated PIM j to the other APs across the inter-AP link 114. If a network includes a large quantity of APs, the APs would not all be attempting to download updated program images from the remote source 110, which can create a communication bottleneck. Instead, updated PIMs can be distributed by providers to respective other APs.

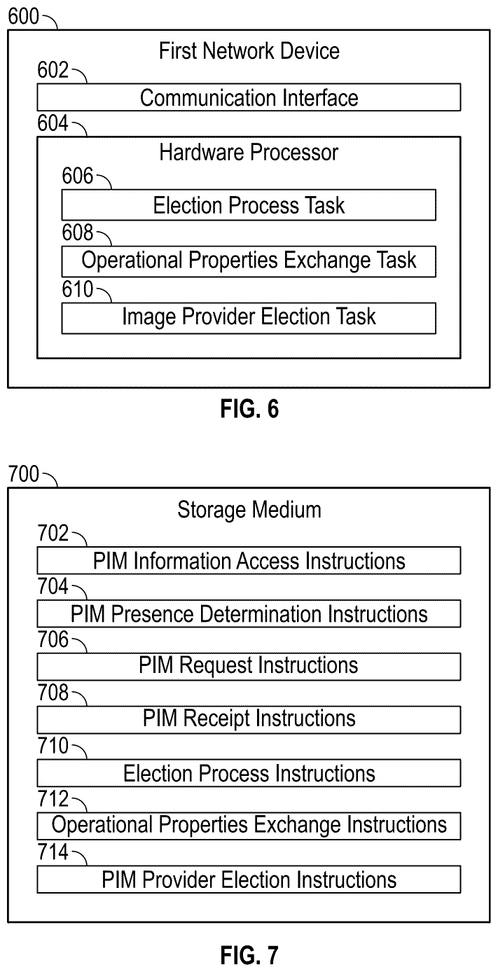

FIG. 6 is a block diagram of a first network device 600, which can be an AP or another type of network device. The first network device 600 includes a communication interface 602 to communicate with other network devices, such as over the inter-AP link 114 of FIG. 1. The communication interface 602 includes a signal transceiver to transmit and receive signals and one or more communication protocol layers that manage communications according to respective communication protocol(s).

The first network device 600 includes a hardware processor 604 (or multiple hardware processors) to perform various tasks. A hardware processor can include a microprocessor, a core of a multi-core microprocessor, a microcontroller, a programmable integrated circuit, a programmable gate array, or another hardware processing circuit. A hardware processor performing a task can refer to a single hardware processor performing the task or multiple hardware processors performing the task.

The tasks of the hardware processor 604 include an election process task 606 to perform an election process with the other network devices to determine which of a plurality of network devices including the first network device and the other network devices is to be a provider of a first PIM of a program image. The program image has been divided into multiple PIMs.

The tasks of the hardware processor 604 include an operational properties exchange task 608 to, as part of the election process, exchange information of operational properties of the plurality of network devices. The exchange includes the first network device 600 sending information of operational properties of the first network device 600 to the other network devices. The exchange further includes the first network device 600 receiving information of operational properties of the other network devices.

The tasks of the hardware processor 604 include an image provider election task 610 to, based on the information of operational properties of the plurality of network devices, determine whether the first network device is elected as the provider of the first PIM. The elected provider is responsible for providing a copy of the first PIM to any other network device that requests the first PIM, and for obtaining updated versions of the first PIM.

In some examples, the information of operational properties include available memory capacities of nonvolatile memories in the plurality of network devices. The determining of whether the first network device is elected as the provider of the first PIM is based on comparing the operational properties including an available memory capacity of a nonvolatile memory in the first network device and available memory capacities of nonvolatile memories in the other network devices. Comparing operational properties of network devices can include computing scores for the respective network devices based on the operational properties and comparing the scores.

In some examples, the operational properties include network performance metrics indicating characteristics of network connections between the plurality of network devices and one or more program image sources (e.g., the remote source 110 of FIG. 1). The determining of whether the first network device is elected as the provider of the first PIM is based on comparing the operational properties including a network performance metric of the first network device and network performance metrics of the other network devices.

In some examples, the operational properties include network device uptime metrics indicating how long the plurality of network devices have been operational. The determining of whether the first network device is elected as the provider of the first PIM is based on comparing the operational properties including a network device uptime metric of the first network device and network device uptime metrics of the other network devices.

In some examples, the operational properties include processing resource usage metrics indicating usage of processing resources in the plurality of network devices. The determining of whether the first network device is elected as the provider of the first PIM is based on comparing the operational properties including a processing resource usage metric of the first network device and processing resource usage metrics of the other network devices.

In some examples, based on determining that the first network device is elected as the provider of the first PIM, the first network device sends a provider elected indication from the first network device to the other network devices, the provider elected indication indicating that the first network device is elected as the provider of the first PIM.

In some examples, the first network device includes a nonvolatile memory. Based on determining that the first network device is elected as the provider of the first PIM, the first network device downloads the first PIM from a program image source, and saves the first PIM downloaded from the program image source to the nonvolatile memory.

In some examples, the first network device receives, from a second network device, a discover message that seeks the first PIM. In response to the discover message, the first network device sends the first PIM retrieved from the nonvolatile memory to the second network device.

In some examples, the first network device downloads an update of the first PIM from the program image source, and sends the update of the first PIM to the other network devices.

In some examples, the first network device includes a nonvolatile memory storing PIM information (e.g., the MT 141 of FIG. 1 or 2) associated with PIMs for the first network device. The first network device determines, based on the PIM information, which subset of PIMs from among the multiple PIMs is to be downloaded to the first network device for the first network device to operate. The subset can include a portion (less than the entirety) of the multiple PIMs, or all of the PIMs. The first network device sends discover messages to other network devices for the PIMs of the subset, and the first network device receives the PIMs of the subset sent by one or more other network devices.

In some examples, the first network device combines the multiple PIMs into the program image to be used at the first network device. The first network device initiates execution of machine-readable instructions of the program image.

In some examples, the first network device detects that a second network device that is a provider of a second PIM of the program image is unavailable. In response to detecting that the second network device is unavailable, the first network device determines whether the second PIM is stored at the first network device. In response to determining that the second PIM is stored at the first network device, the first network device elects the first network device as the provider of the second PIM, and sends a provider elected indication indicating that the first network device is elected as the provider of the second PIM.

In some examples, the first network device detects that a second network device that is a provider of a second PIM of the program image is unavailable. The first network device determines whether a further network device has sent a provider elected indication indicating that the further network device is elected as the provider of the second PIM.

In some examples, in response to determining that no network device has sent the provider elected indication, the first network device initiates a further election process among available network devices of the plurality of network devices to elect one of the available network devices as the provider of the second PIM.

In some examples, based on the first network device being elected as the provider of the second PIM by the further election process, the first network device downloads the second PIM from a program image source.

In some examples, the first network device performs a backup election process with the other network devices to determine which of the plurality of network devices is to be a backup provider of a second PIM of the program image, the backup provider providing backup for a primary provider of the second PIM.

FIG. 7 is a block diagram of a non-transitory machine-readable or computer-readable storage medium 700 storing machine-readable instructions that upon execution cause a first network device to perform various tasks.

The machine-readable instructions include PIM information access instructions 702 to access PIM information to determine which PIMs divided from a program image are to be used to form a program image executed in the first network device. The PIM information can include the MT 141 of FIG. 1 or 2, for example.

The machine-readable instructions include PIM presence determination instructions 704 to determine, based on the PIM information, that a first PIM is not present in a nonvolatile memory of the first network device. This can be based on the MP flag 210 (FIG. 2) of the MT entry for the first PIM, for example.

The machine-readable instructions include PIM request instructions 706 to send, from the first network device, a request for the first PIM. The request can be a discover message broadcast to multiple network devices, for example.

The machine-readable instructions include PIM receipt instructions 708 to receive, at the first network device, the first PIM from a second network device. The first PIM is sent by the second network device in response to the request from the first network device.

The machine-readable instructions include election process instructions 710 to perform an election process with other network devices to determine which of a plurality of network devices is to be a provider of a second PIM of the program image.

The machine-readable instructions include operational properties exchange instructions 712 to, as part of the election process, exchange information of operational properties of the plurality of network devices.

The machine-readable instructions include PIM provider election instructions 714 to, based on the information of operational properties of the plurality of network devices, determine whether the first network device is elected as the provider of the second PIM. The election can be based on comparing the operational properties of the plurality of network devices.

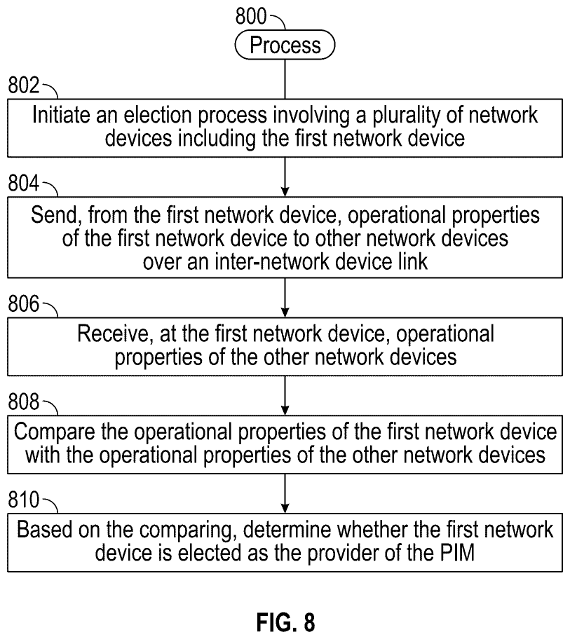

FIG. 8 is a flow diagram of a process 800 according to some examples. The process 800 may be performed by a first network device, for example. The process 800 includes initiating (at 802) an election process involving a plurality of network devices including the first network device to elect a provider of a PIM.

As part of the election process, the process 800 includes sending (at 804), from the first network device, operational properties of the first network device to other network devices over an inter-network device link, and receiving (at 806), at the first network device, operational properties of the other network devices.

The process 800 includes comparing (at 808) the operational properties of the first network device with the operational properties of the other network devices. This comparison can include a comparison of scores derived from the operational properties.

Based on the comparing, the process 800 includes determining (at 810) whether the first network device is elected as the provider of the PIM.

A storage medium (e.g., 700 in FIG. 7) can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A first network device comprising:
a communication interface to communicate with other network devices; and
a hardware processor to:
perform an election process with the other network devices to determine which of a plurality of network devices including the first network device and the other network devices is to be a provider of a first program image module of a program image divided into multiple program image modules;
as part of the election process, exchange information of operational properties of the plurality of network devices; and
based on the information of operational properties of the plurality of network devices, determine whether the first network device is elected as the provider of the first program image module.

2. The first network device of claim 1, wherein the operational properties comprise available memory capacities of nonvolatile memories in the plurality of network devices, and wherein the determining of whether the first network device is elected as the provider of the first program image module is based on comparing the operational properties including an available memory capacity of a nonvolatile memory in the first network device and available memory capacities of nonvolatile memories in the other network devices.

3. The first network device of claim 1, wherein the operational properties comprise network performance metrics indicating characteristics of network connections between the plurality of network devices and one or more program image sources, and wherein the determining of whether the first network device is elected as the provider of the first program image module is based on comparing the operational properties including a network performance metric of the first network device and network performance metrics of the other network devices.

4. The first network device of claim 1, wherein the operational properties comprise network device uptime metrics indicating how long the plurality of network devices have been operational, and wherein the determining of whether the first network device is elected as the provider of the first program image module is based on comparing the operational properties including a network device uptime metric of the first network device and network device uptime metrics of the other network devices.

5. The first network device of claim 1, wherein the operational properties comprise processing resource usage metrics indicating usage of processing resources in the plurality of network devices, and wherein the determining of whether the first network device is elected as the provider of the first program image module is based on comparing the operational properties including a processing resource usage metric of the first network device and processing resource usage metrics of the other network devices.

6. The first network device of claim 1, wherein the hardware processor is to:
based on determining that the first network device is elected as the provider of the first program image module, send a provider elected indication from the first network device to the other network devices, the provider elected indication indicating that the first network device is elected as the provider of the first program image module.

7. The first network device of claim 1, further comprising:
a nonvolatile memory,
wherein the hardware processor is to:
based on determining that the first network device is elected as the provider of the first program image module, download the first program image module from a program image source, and save the first program image module downloaded from the program image source to the nonvolatile memory.

8. The first network device of claim 7, wherein the hardware processor is to:
receive, from a second network device, a discover message that seeks the first program image module; and
in response to the discover message, send the first program image module retrieved from the nonvolatile memory to the second network device.

9. The first network device of claim 7, wherein the hardware processor is to:
download an update of the first program image module from the program image source; and
send the update of the first program image module to the other network devices.

10. The first network device of claim 1, further comprising:
a nonvolatile memory storing program image module information associated with program image modules for the first network device,
wherein the hardware processor is to:
determine, based on the program image module information, which subset of program image modules from among the multiple program image modules is to be downloaded to the first network device for the first network device to operate;
send discover messages to other network devices for the program image modules of the subset;
receive the program image modules of the subset sent by one or more network devices of the other network devices.

11. The first network device of claim 10, wherein the hardware processor is to:
combine the multiple program image modules into the program image to be used at the first network device; and
initiate execution of machine-readable instructions of the program image.

12. The first network device of claim 1, wherein the hardware processor is to:
detect that a second network device that is a provider of a second program image module of the program image is unavailable;
in response to detecting that the second network device is unavailable, determine whether the second program image module is stored at the first network device; and
in response to determining that the second program image module is stored at the first network device, elect the first network device as the provider of the second program image module, and send a provider elected indication indicating that the first network device is elected as the provider of the second program image module.

13. The first network device of claim 1, wherein the hardware processor is to:
detect that a second network device that is a provider of a second program image module of the program image is unavailable;
determine whether a further network device has sent a provider elected indication indicating that the further network device is elected as the provider of the second program image module.

14. The first network device of claim 13, wherein the hardware processor is to:
in response to determining that no network device has sent the provider elected indication, initiate a further election process among available network devices of the plurality of network devices to elect one of the available network devices as the provider of the second program image module.

15. The first network device of claim 14, wherein the hardware processor is to:
based on the first network device being elected as the provider of the second program image module by the further election process, download the second program image module from a program image source.

16. The first network device of claim 1, wherein the hardware processor is to:
perform a backup election process with the other network devices to determine which of the plurality of network devices is to be a backup provider of a second program image module of the program image, the backup provider providing backup for a primary provider of the second program image module.

17. A non-transitory machine-readable storage medium comprising instructions that upon execution cause a first network device to:
access program image module information to determine which program image modules divided from a program image are to be used to form a program image executed in the first network device;
determine, based on the program image module information, that a first program image module is not present in a nonvolatile memory of the first network device;
send, from the first network device, a request for the first program image module;
receive, at the first network device, the first program image module from a second network device;
perform an election process with other network devices to determine which of a plurality of network devices including the first network device and the other network devices is to be a provider of a second program image module of the program image;
as part of the election process, exchange information of operational properties of the plurality of network devices; and
based on the information of operational properties of the plurality of network devices, determine whether the first network device is elected as the provider of the second program image module.

18. The non-transitory machine-readable storage medium of claim 17, wherein the program image module information comprises a first entry for the first program image module, and a second entry for the second program image module, and wherein the instructions upon execution cause the first network device to:
update the first entry for the first program image module by adding information identifying the second network device as the provider of the first program image module; and
update the second entry for the second program image module by adding an indicator that the first network device is the provider of the second program image module.

19. A method comprising:
initiating, at a first network device, an election process involving a plurality of network devices including the first network device to elect a provider of a program image module that is part of a plurality of program image modules divided from a program image;
as part of the election process,
sending, from the first network device, operational properties of the first network device to other network devices over an inter-network device link, and
receiving, at the first network device, operational properties of the other network devices;
comparing, at the first network device, the operational properties of the first network device with the operational properties of the other network devices;
based on the comparing, determining, by the first network device, whether the first network device is elected as the provider of the program image module.

20. The method of claim 19, further comprising:
detecting, by the first network device, that a second network device that is a provider of a second program image module of the program image is unavailable;
in response to detecting that the second network device is unavailable, determining, by the first network device, whether the second program image module is stored at the first network device; and
in response to determining that the second program image module is stored at the first network device, setting the first network device as the provider of the second program image module, and sending, from the first network device, a provider elected indication indicating that the first network device has been set as the provider of the second program image module.
